(19) United States
(12) Patent Application Publication
(10) Pub. No.: US 2025/0173937 A1
(43) Pub. Date: May 29, 2025

(54) ARTIFICIAL INTELLIGENCE DEVICE FOR IMAGE AUGMENTED SPEECH-DRIVEN 3D FACIAL ANIMAION AND METHOD THEREOF

(71) Applicant: LG ELECTRONICS INC., Seoul (KR)

(72) Inventors: Mathieu TULI, Toronto (CA); Eu Wern TEH, Toronto (CA); Felix TAUBNER, Toronto (CA); Jinmiao HUANG, Toronto (CA); Prashant RAINA, Toronto (CA)

(73) Assignee: LG ELECTRONICS INC., Seoul (KR)

(21) Appl. No.: 18/959,149

(22) Filed: Nov. 25, 2024

Related U.S. Application Data
(60) Provisional application No. 63/602,456, filed on Nov. 24, 2023.

(51) Int. Cl. G06T 13/20; G06T 13/40; G06T 17/20

(52) U.S. Cl. CPC G06T 13/205; G06T 13/40; G06T 17/20

(57) ABSTRACT

A method for speech-driven three dimensional (3D) facial animation can include receiving an input speech audio signal, generating a speaker style vector from the input speech audio signal based on a speaker style embedding model, inputting the input speech audio signal and the speaker style vector into a mesh generation model and generating vertex position information for a 3D facial animation based on the input speech audio signal and the speaker style vector, and outputting the vertex position information.

### CROSS-REFERENCE TO RELATED APPLICATIONS

This non-provisional application claims priority under 35 U.S.C. § 119 (c) to U.S. Provisional Application No. 63/602,456, filed on Nov. 24, 2023, the entirety of which is hereby expressly incorporated by reference into the present application.

### BACKGROUND

### Field

The present disclosure relates to a device and method for neural network driven three dimensional (3D) animation, in the field of artificial intelligence (AI). Particularly, the method can use a trained AI model to generate realistic and expressive facial animations from speech audio.

### Discussion of the Related Art

Artificial intelligence (AI) continues to transform various aspects of society and help users by powering advancements in various fields, particularly with regards to computer graphics, animation and interactive applications.

Creating realistic and expressive facial animation is a persistent challenge in computer graphics, which can be manually time consuming and expensive, especially when trying to produce facial animations that accurately match speech and audio.

Building speech-driven generative models that can produce high-fidelity 3D animations is an important problem within AI that has broad applications to fields, such as gaming, virtual reality, film production and online communication.

While some generative models exist, generating 3D facial animations that accurately match speech is a complex challenge due to the intricate relationships between audio signals and the subtle movements of facial muscles. For example, the timing and dynamics of speech sounds should be precisely synchronized with the movements of the mouth, lips and tongue, and even the subtle expressions conveyed through the eyes, checks and head movements. For instance, mapping of speech (e.g., audio) signals to high-dimensional 3D data (e.g., facial meshes) is an ambiguous one-to-many problem, where one speech input can map to more than one compatible animation or style (e.g. variations in emotion, expression, etc.), which can often lead to unexpressive and low-fidelity animations due to an averaging of motions.

Existing methods often struggle to capture these intricate relationships, particularly with variations in speaking styles, accents and emotions. This can lead to animations that appear unnatural, out-of-sync, or lacking in the expressiveness that characterizes human communication and human emotions (e.g., resulting in the infamous “uncanny valley”).

Also, another obstacle is the scarcity of high-quality 3D facial animation data for training AI models. Acquiring such data often uses expensive and time-consuming methods like motion capture or meticulous manual annotation and labeling, which limits the amount of training data available for developing robust animation models. This data scarcity problem directly impacts the quality and diversity of animations that can be produced by models.

In addition, in order to try and address different speaking styles, existing models employ simple one-hot encoding of speaker identities or pre-defined speaking styles, which fail to capture the rich complexity of individual voices and limit the ability to generalize to new speakers and styles that have not been previously observed by the model.

Accordingly, there exists a need for a method that can achieve realistic and expressive facial animation in interactive applications by leveraging neural networks to predict and generate facial movements with high fidelity and accuracy. For example, there exists a need for a solution that can automatically generate high-quality 3D facial animation based on an input speech that includes accurate movements and expressions that can dynamically match the given style of the input speech.

Further, a need exists for a method that can generate augmented training data for training an AI model to generate more realistic and expressive facial animations. Accordingly, a need exists for a method that can include an improved loss function, advanced speaker style embeddings and augmented training data generation to produce a better speech-driven 3D animation model that can provide realistic and expressive facial animation that accurately matches audio.

### SUMMARY OF THE DISCLOSURE

The present disclosure has been made in view of the above problems and it is an object of the present disclosure to provide a device and method that can provide speech-driven 3D facial animation, in the field of artificial intelligence (AI). Further, the method can automatically generate 3D facial animations by predicting vertex positions for meshes based on a speech input.

An object of the present disclosure is to provide a method for controlling an artificial intelligence (AI) device that can generate realistic and expressive 3D facial animations from speech audio using a sophisticated 3D facial animation model that incorporates a 2D photometric loss function, ensuring both geometric accuracy and visual realism in the generated animations. Also, the method can employ advanced speaker embeddings extracted using a speaker style embedding model which can capture individual speaker styles and enable the generation of animations that accurately reflect the nuances of speech, including variations in emotion and speaking rate. Further, the method can include generating augmented training data for training the animation model by converting 2D facial datasets into 3D training data through a data augmentation process. This augmented data can be used to further train the animation model. In this way, the method can produce high-quality, personalized and expressive 3D facial animations that overcome many limitations of the existing technology.

Another object of the present disclosure is to provide a method for speech-driven three dimensional (3D) facial animation that includes receiving, by a processor, an input speech audio signal, generating, by the processor, a speaker style vector from the input speech audio signal based on a speaker style embedding model, inputting, by the processor, the input speech audio signal and the speaker style vector into a mesh generation model and generating vertex position information for a 3D facial animation based on the input speech audio signal and the speaker style vector, and outputting, by the processor, the vertex position information.

It is another object of the present disclosure to provide a method that includes displaying the 3D facial animation with animated movements based on the vertex position information.

Yet another object of the present disclosure is to provide a method, in which the mesh generation model is trained based on a two dimensional (2D) photometric loss function based on inverse rendering of predicted vertex position information and corresponding ground truth vertex position information.

An object of the present disclosure to provide a method, in which the 2D photometric loss function includes a mask parameter configured to remove background information to isolate a face.

Another object of the present disclosure to provide a method, in which the 2D photometric loss function is based on a pixel difference between two 2D images.

An object of the present disclosure to provide a method, in which the mesh generation model is trained based on a Mean Squared Error (MSE) loss function.

Yet another object of the present disclosure to provide a method, in which the vertex position information includes a tensor of dimension NUMFRAMES×VERTEXCOUNT×3, where NUMFRAMES is a number of frames based on a length of input speech audio signal, VERTEXCOUNT is a number of vertices based on a mesh for the 3D facial animation, and 3 corresponds to x, y and z coordinates.

An object of the present disclosure to provide a method, in which the mesh generation model is trained based on augmented training data that includes 3D animation data generated based on 2D videos.

Another object of the present disclosure to provide a method, in which the generating the speaker style vector includes inputting feature vectors based on the input speech audio signal to a transformer encoder and processing the feature vectors through transformer blocks that include self-attention operations, and generating the speaker style vector based on an output of the transformer encoder.

An object of the present disclosure to provide a method, in which the mesh generation model includes a transformer-based vertex decoder configured with causal self-attention and cross-modal attention.

Another object of the present disclosure is to provide an artificial intelligence (AI) device including a memory configured to store facial animation information and a controller configured to receive an input speech audio signal, generate a speaker style vector from the input speech audio signal based on a speaker style embedding model, input the input speech audio signal and the speaker style vector into a mesh generation model to generate vertex position information for a 3D facial animation based on the input speech audio signal and the speaker style vector, and output the vertex position information.

An object of the present disclosure is to provide an AI device that includes a display configured to display an image, in which the controller is further configured to display, via the display, the 3D facial animation with animated movements based on the vertex position information

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4, including parts (a) and (b), shows examples of blendshapes and a mesh, according to embodiments of the present invention.

FIG. 5 illustrates an example flow chart for a method of 3D speech-driven facial animation according to an embodiment of the present invention.

FIG. 6 illustrates an overview of the architecture of an AI model for 3D speech-driven facial animation, according to an embodiment according to an embodiment.

FIG. 7 illustrates a detailed overview of the architecture of an AI model for 3D speech-driven facial animation, according to an embodiment according to an embodiment.

FIG. 8 shows input 2D videos and generated 3D facial mesh reconstructions for training data, according an embodiment of the present disclosure.

FIG. 9, including parts (a), (b) and (c), shows T-SNE plots of speaker embeddings, according to embodiments of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

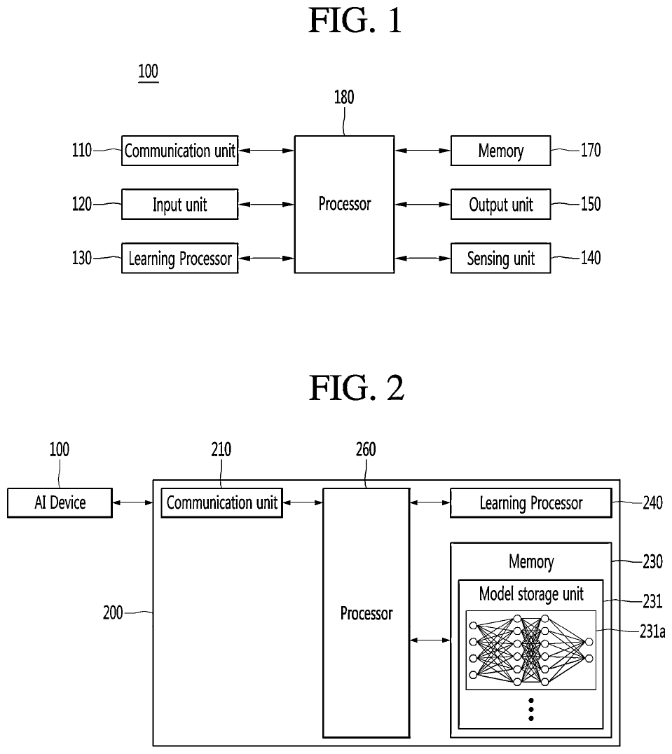

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

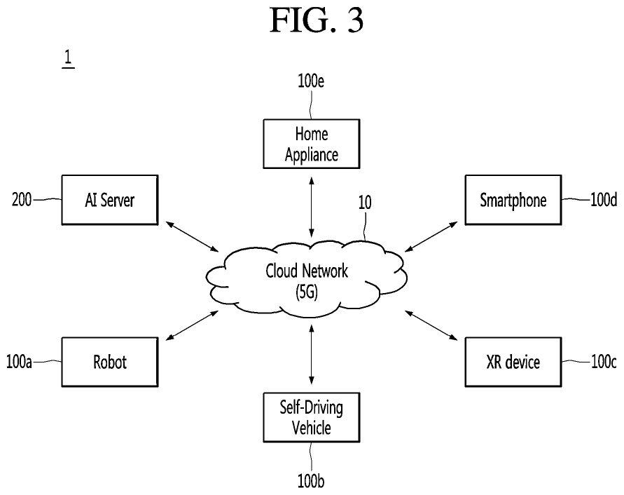

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement neural network driven vertex animation and can animate facial expressions by predicting vertex positions and generating blendshapes while improving latency and compatibility.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information from the user input and can determine an answer, carry out an action or movement, animate a displayed avatar or a recommend an item or action based on the acquired information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100c.

At this time, the AI server 200 can learn the artificial neural network according to the machine learning algorithm instead of the AI devices 100a to 100e, and can directly store the learning model or transmit the AI model to the AI devices 100a to 100c.

At this time, the AI server 200 can receive input data from the AI devices 100a to 100c, can infer the result value for the received input data by using the learning model, can generate a response or a control command based on the inferred result value, and can transmit the response or the control command to the AI devices 100a to 100c. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart refrigerator or other display device, which can implement one or more of an animation method, digital avatar assistant, a question and answering system or a recommendation system using an animated avatar, etc. Also, the avatar can perform virtual product demonstrations and provide user tutorials and maintenance tutorials. The method can be the form of an executable application or program.

The robot 100a, to which the AI technology is applied, can be implemented as an entertainment robot, a guide robot, a carrying robot, a cleaning robot, a wearable robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the learning model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar with animated facial movements and expressions.

According to an embodiment, the AI device 100 can provide neural network driven vertex animation, and animate facial expressions by predicting vertex positions based on a speech input.

According to another embodiment, the AI device 100 can be integrated into an infotainment system of the self-driving vehicle 100b in the form of a digital avatar, which can recognize different users and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, generating realistic 3D facial animations that accurately match speech is difficult due to several factors, including complexity of facial movements, speaker variability, and scarcity of training data. For example, the subtle and intricate muscle movements required for natural-looking speech are hard to capture and synchronize with audio. Also, differences in speaking styles, accents and emotions make it challenging to create animations that work across a variety of speakers. Further, existing techniques, such as one-hot encoding, are too simplistic to capture the nuances of individual voices and struggle to generalize to new speakers.

Developers typically animate faces and models using either blendshapes (e.g., predefined facial expressions) or by directly manipulating mesh vertices (e.g., individual points that define the 3D model). Blendshapes can be efficient but can lack detail and require artistic skill and labor to create. Also, vertex manipulation can offer fine-grained control but can be time-consuming and computationally expensive.

In more detail, blendshapes are a set of predefined 3D shapes or states that a 3D model can smoothly transition between. These shapes can be used to alter the geometry of a character's face or body. Each blendshape represents a specific deformation or pose of the mesh, such as smiling, frowning, blinking, or any other facial expression or shape change.

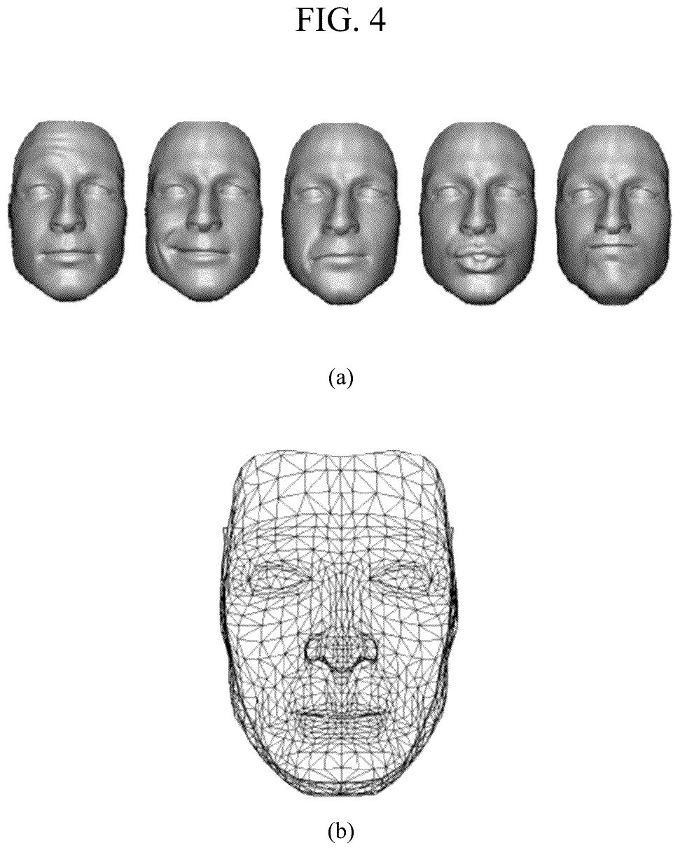

FIG. 4, part (a) shows an example of blendshapes that include a right eyebrow raise, a right lip corner smile, a right lip corn frown, a lip pucker and a chin raise. For example, blendshapes are primarily used for character animation. Instead of deforming the character's mesh using complex skeletal rigging and bone-based animations, blendshapes allow for precise control over the character's facial expressions and other deformations.

For example, a blendshape is a type of morph target used for a 3D model deformation technique where a set of predefined target shapes can be used to alter the geometry of a base mesh. Each blendshape can represent a specific expression or deformation, such as a smile, frown, or raised eyebrow, etc. By blending between these target shapes with varying weights, a wide range of facial expressions and body movements can be created. Blendshapes can be used for characters in video games, digital avatars and animated films.

Animators can create a range of expressions and deformations by blending between different shapes, hence the name “blendshapes.”

Blendshapes are computationally efficient and can be calculated and interpolated in real-time by a game engine, making them suitable for interactive applications like games. This efficiency can help maintain smooth animations at high frame rates and for a large number of vertices.

However, creating blendshapes can be a time-consuming and skill-intensive process, which poses significant challenges when attempting to swiftly generate custom avatars from scanned or photographed user head data. These hurdles can hinder the widespread application of this technology for personalized avatar generation or reconstruction. Also, per vertex control fidelity is limited to the number of blendshapes used.

FIG. 4, part (b) shows an example of a mesh which is a polygonal surface that describes the geometric surfaces of a face or other object. For example, a mesh refers to a 3D model or object that is represented as a collection of vertices, edges, and faces (e.g., polygons) to create a 3D shape or structure.

Meshes can be used to represent and render objects and characters in 3D environments. A mesh defines the geometric structure of a 3D object by specifying the positions of its vertices in 3D space. These vertices are connected to form edges and faces, which define the shape of the object. Vertices are the individual points in 3D space that make up the mesh. Edges connect vertices, and faces are formed by connecting multiple vertices and edges to create flat surfaces (e.g., polygons, triangles or quadrilaterals). The combination of vertices, edges, and faces gives the mesh its shape.

In addition, a mesh can provide individual vertex control that offers a superior level of detail, enabling the portrayal of facial expressions that might prove challenging to achieve through blendshape blending alone. Also, mesh animation can allow developers a greater degree of creative freedom.

However, manually controlling mesh vertices poses greater technical complexity and demands more time from artists, especially when dealing with facial animations requiring intricate vertex-level precision. Additionally, compatibility with real-time rendering engines can be difficult, e.g., setting each vertex position individually for every frame can be slow and tedious in game engines.

According to an embodiment, the AI device and method can improve computer animation. For example, according to an embodiment, the method can include automatically generating realistic 3D facial animations from speech audio input by using speaker style vector embeddings with a model trained on pixel-space loss that accurately captures speaker characteristics and produces visually realistic animations.

In more detail, the method can receive speech audio as input and use a speaker style embedding model to analyze it, producing a speech style vector that represents the speaker's unique characteristics. This vector, along with the raw audio, can be fed into a trained model (e.g., a mesh generation model) that generates a 3D facial animation. This animation can include a sequence of meshes that can be used for various purposes.

In addition, to improve the visual realism of the animation, the model can be trained based on comparing rendered videos of the predicted animation and the ground truth animation, using a pixel-space loss as an additional regularization signal.

For example, the model can better learn the relationships between the 3D mesh vertices and their appearance when rendered as a 2D image. In this way, the method can significantly improve the model's ability to capture speaker styles and generalize to new speakers, leading to better overall results.

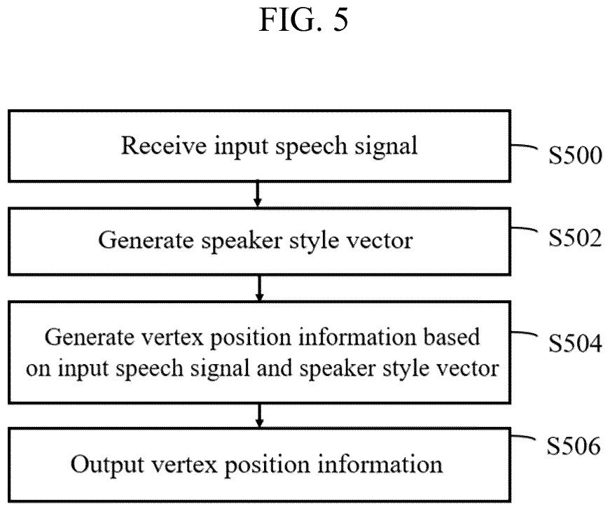

FIG. 5 shows an example flow chart of a method according to an embodiment. For example, according to an embodiment, a method speech-driven three dimensional (3D) facial animation can include receiving, by a processor, an input speech audio signal (e.g., S500), generating, by the processor, a speaker style vector from the input speech audio signal based on a speaker style embedding model (e.g., S502), inputting, by the processor, the input speech audio signal and the speaker style vector into a mesh generation model and generating vertex position information for a 3D facial animation based on the input speech audio signal and the speaker style vector (e.g., S504), and outputting, by the processor, the vertex position information (e.g., S506).

Also, the method can further include displaying the 3D facial animation with animated movements based on the vertex position information.

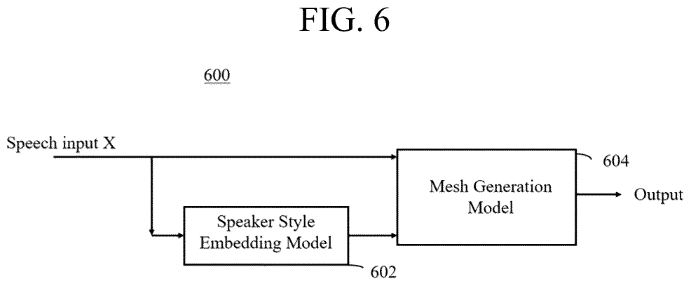

FIG. 6 shows an example overview of the architecture of the trained AI model (e.g., 600), according to an embodiment. For example, the AI model (e.g., 600) can include two main components including a speech style embedding model (e.g., 602) and a mesh generation model (e.g., 604), but embodiments are not limited thereto. For example, other variations can be implemented.

For example, a speech input X can be input into the speech style embedding model (e.g., 602), which can generate a speech style embedding vector of dimension 64 (e.g., an array of 64 floating point values). Then, the original speech input X and the speech style embedding vector can be input to the mesh generation model (e.g., 604) which takes these inputs and translates them into a sequence of meshes, representing an animation, in which the mesh generation model can be trained based on a 2D photometric loss function.

The output generated by the mesh generation model can be a tensor of dimension (NUMFRAMES, VERTEXCOUNT, 3), where NUMFRAMES is a number of frames relative to the input audio length, and VERTEXCOUNT is a number of vertices relative to the mesh, and 3 corresponds to x, y and z coordinates for a vertex position. Also, the AI model can be trained on augmented training data in which a pseudo-labeling technique can be used for generating 3D animation data from 2D videos.

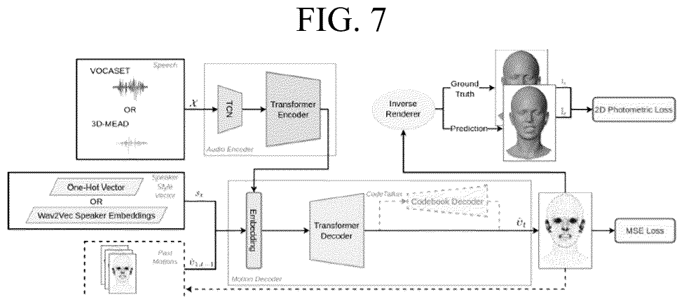

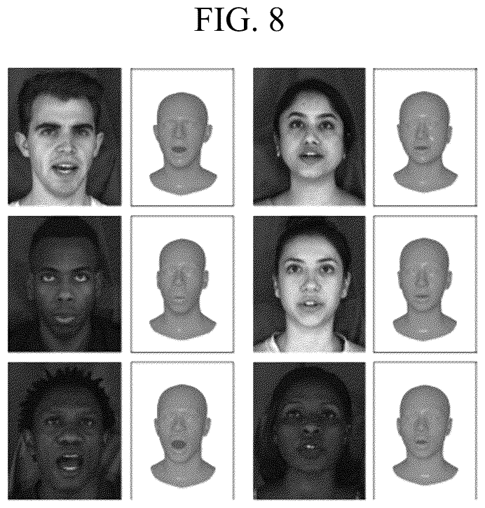

FIG. 7 shows an example overview architecture of the trained AI model in more detail, according to an embodiment, which can include a data augmentation component (e.g., 3D-MEAD training data), a speaker style component, and a mesh generation component based on 2D photometric loss, which are described in more detail below.

Regarding data augmentation, the AI model can be trained on various existing datasets as well as augmented training data generated using one or more existing datasets.

For example, creating 3D facial animation datasets often requires expensive and time-consuming motion capture, limiting the availability of such data. According to an embodiment, a technique can be employed that uses a dense-landmark prediction model to generate 3D facial animation data directly from 2D videos. This model can predict the location of many points on the face, not just a few key landmarks.

For example, the data augmentation technique can be applied to existing datasets, such as MEAD. The MEAD dataset is a large-scale resource for studying emotional talking faces, featuring high-quality videos of 60 actors expressing eight different emotions at three intensity levels, captured from seven viewpoints simultaneously.

According to an embodiment, training data generation model can have a two-stage pipeline to generate 3D facial animation from 2D video, in which the 3D facial animation can be used as training data.

For example, the training data generation model can include a 2D alignment network that include a vision transformer (e.g., Segformer encoder) and a recurrent update block (e.g., which can be based on Recurrent All-Pairs Field Transforms RAFT) that predicts the location of each vertex of a 3D face model in the video. This network can be trained on high-quality 3D scan data to achieve dense per-vertex alignment.

For example, the recurrent update block model can be adapted for the specific task of dense 3D face tracking from 2D video. The recurrent update block model can take the 4D correlation volume, context map, and hidden state as inputs to refine the alignment between a 2D image and a 3D face model. The correlation volume can provide initial correspondences between image and UV features, while the context map can provide global facial information. The hidden state can provide information from previous iterations, enabling the network to learn from past refinements. As outputs, the recurrent update block model can produce an updated UV-to-image flow map, representing refined 2D locations of 3D face points, an updated uncertainty map reflecting confidence in those locations, and an updated hidden state to inform the next iteration. This iterative process can allow for progressively improved alignment between the image and the 3D face model.

In addition, the training data generation model can further include an optimization module that fits the 3D face model to the predicted vertex locations across multiple frames, which can include incorporating shape and expression priors to reconstruct a time-consistent 3D animation of the face, including detailed geometry, head pose and facial expressions. The 3D model fitting process can include an optimizing energy function that measures the difference between the predicted 2D vertex locations and the projected 3D vertex locations from the 3D face model (e.g., which can be based on the FLAME model). According to an embodiment, the training data generation model can be referred to as FlowFace.

FIG. 8 shows input 2D videos and corresponding generated 3D facial mesh reconstructions which can be used as training data. For example, given a 2D video sequence I={l₁, . . . , l_{T}}, it ∈R^{W×H}, the method can generate ground-truth facial mesh sequences Γ_{1:T}={v₁, . . . , v_{T}}. These generated ground-truth facial mesh sequences can be used to train the AI model, which is described in more detail at a later section below. According to an embodiment, the generated ground-truth facial mesh sequences can be referred to as a 3D-MEAD dataset, but embodiments are not limited thereto. For example, other types of 2D video with corresponding audio can be used to generate ground-truth 3D facial mesh sequences.

With reference again to FIG. 7, the method can utilize speaker style embeddings. For example, the generated speaker style embeddings can help the model adapt to new speakers in a zero-shot manner. Instead of using one-hot encoding, the method can include implementing a trained speaker style embedding model to extract a latent code from the speech input.

The speaker style embedding model can include a convolution neural network (CNN) for reducing dimensionality of the audio data, converting the raw audio waveform into a sequence of feature vectors. Also, the speaker style embedding model can further include a transformer encoder that can take the feature vectors and process them through transformer blocks which can include self-attention operations. Also, the final output of the speaker style embedding model can be a single vector (e.g., an array of 64 floating point values), which can be referred to as a speaker style vector.

The speaker style vector can represent the unique characteristics of a speaker's voice, e.g., accent, speaking rate, and typical intonation patterns. The speaker style vector can be used by the AI model to personalize the 3D facial animation, making it more expressive and better reflecting the individual speaker's style and emotions.

For example, the speaker style embedding model can be fine-tuned on speaker identification tasks to extract a latent code from the speech input. This code can capture both unique speaker characteristics and nuances in their speech, such as emotion and pace. A learnable linear layer can be used that maps this latent code into a 64-dimensional style feature vector. In this way, a more expressive and accurate representation of speaker styles can be utilized, enabling the model to generalize to unseen speakers.

According to an embodiment, the speaker style embedding model can include a modified Wave2Vec 2.0 model, in which the last portion regarding individual speaker identification is removed or adjusted, and the generated speech vector is used to provide a contextualized vector representation of the input speech, but embodiments are not limited thereto. For example, other models and variations can be used that generate a vector representation of speech.

In more detail, a model based on Wave2Vec 2.0 can be used to encode speech inputs X, according to an embodiment. For example, Wave2Vec 2.0 is a generalized model that features an audio feature extractor and transformer-based encoder. The audio feature extractor is composed of temporal convolutions networks (TCN) and processes raw waveforms into feature vectors that the encoder converts to contextualized speech representations. Wav2Vec's output can be resampled to match the sampling frequency (e.g., 16 kHz). Further, according to an embodiment, during training, the TCN and encoder can be initialized and frozen with pretrained Wav2Vec 2.0 weights, and a randomly initialized linear projection layer can be added on top.

Further, the method can include mapping speaker styles to a common feature space using the input speech signal directly rather than a one-hot encoding. That is, given a speech input X, a latent code A(S)=W_{X} can be extracted using a learned audio encoder A(S) that better represents the speaker as well as the nuances of their speech. Also, as mentioned above, a learnable linear layer can then be used to map this latent code into a speaker style feature vector Zₓ∈R⁶⁴.

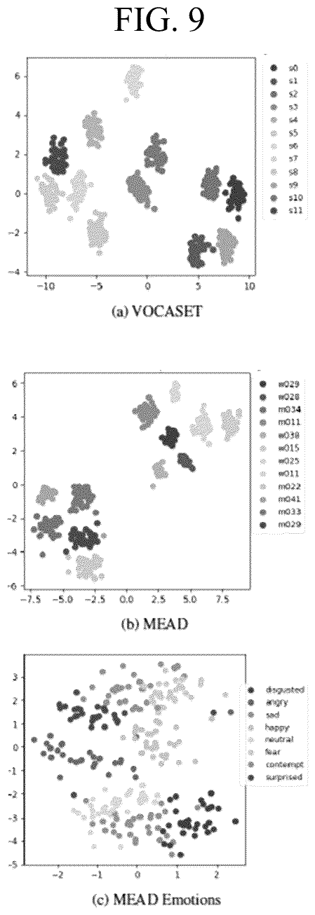

For example, FIG. 9 shows T-SNE plots of speaker embeddings, in which part (a) shows all 12 speakers in VOCASET, part (b) shows 12 random MEAD speakers, and part (c) shows various emotion-labeled speeches for a randomly selected speaker in the MEAD dataset. The T-SNE plots in FIG. 9 demonstrate how the speaker style embedding model can produce speaker vector embeddings that are able to separate speaker identities as well as sufficiently differentiate emotions within the same speaker.

With reference again to FIGS. 6 and 7, according to an embodiment, the AI model can include a mesh generation model. For example, the mesh generation model can include a transformer-based decoder to generate 3D facial animations from the input audio and the speech style vector, incorporating both causal self-attention for temporal consistency and cross-modal attention for audio-visual alignment.

In addition, the mesh generation model can be trained using a dual loss function that combines Mean Squared Error (MSE) for accurate vertex prediction and a novel 2D photometric loss, which compares rendered images of the predicted and ground truth animations to improve visual realism and alignment in 2D image space. In this way, the model can generate higher-fidelity 3D animations.

For example, the Mean Squared Error (MSE) can be defined as Equation 1, below.

$${ℒ}_{MSE} ( {\hat{Γ}}_{1 : T} , {Γ}_{1 : T} ) = {‖ \hat{{Γ}_{1 : T}} - {Γ}_{1 : T} ‖}_{2}^{2} \qquad [ Equation 1 ]$$

$$where$$

$${‖ \hat{{Γ}_{1 : T}} - {Γ}_{1 : T} ‖}_{2}^{2} = {\sum }_{t = 1}^{T} {\sum }_{n = 1}^{V} {‖ {\hat{v}}_{t , n} - {v}_{t , n} ‖}^{2}$$

In Equation 1, V is the number of 3D vertices in the set of vertex offsets (e.g., vₗ∈R^{V×3}).

As discussed above, the mesh generation model can be trained based on the Mean Squared Error (MSE) loss in addition to a 2D photometric loss.

For example, the 2D photometric loss can be defined as Equation 2, below.

$${ℒ}_{PHO} = {\sum }_{t = 1}^{T} {‖ {V}_{1} ⊙ ( {\hat{𝕀}}_{t} - {𝕀}_{t} ) ‖}_{1 , 1} , \qquad [ Equation 2 ]$$

In Equation 2, V_{I} is a mask that removes the background to isolate the face, and ⊙ is the Hadamard product. Occluding the background in this manner is useful to focus on the facial features and not dilute the changes between prediction and ground truth. In this way, the 2D photometric loss can introduce additional regularization and ensure that the rendered predictions align with the rendered ground truth.

For example, 2D photometric loss can enhance the realism of the generated 3D facial animations by ensuring that the animations not only accurately represent the 3D geometry of the face but also appear accurate when rendered as 2D images.

According to an embodiment, the model can take a predicted 3D animation frame and apply a technique referred to as “inverse rendering.” This inverse rendering can effectively simulate how the 3D animation would appear as a 2D image from a specific viewpoint and under particular conditions. The same process is then applied to the corresponding ground truth 3D animation frame, creating a second 2D image.

Then a feature of the 2D photometric loss is based on comparing these two rendered images. For example, it can carefully calculate the difference between the predicted and ground truth images by examining their pixel values. This difference quantifies how well the predicted animation matches the visual appearance of the ground truth when rendered in 2D. In other words, it gives the model an additional signal to train on.

In addition, the further refine this comparison, the model can employ a masking technique. This mask focuses the analysis on the facial region, excluding any background elements that might distract from the evaluation of the facial features themselves. By concentrating on the pixel differences within the face, the 2D photometric loss function can effectively prioritize the accuracy and realism of the facial animation.

During the training process, which is discussed in more detail below, the AI model tries to minimize this 2D photometric loss in conjunction with the Mean Squared Error (MSE) (e.g., the 3D loss), which measures the accuracy of the 3D vertex positions. This dual optimization strategy can better encourage the model to generate animations that are both geometrically precise and visually convincing when rendered as 2D images.

In other words, the 2D photometric loss can act as a type of feedback mechanism, allowing the model to view its 3D animation through the lens of a 2D image and compare it to the ground truth. This additional guidance can help the model produce better 3D facial animations.

According to an embodiment, the Mean Squared Error (MSE) loss component and the 2D photometric loss component can be weighted differently. For example, more weight may be given to the Mean Squared Error (MSE) loss component while less weight is given to the contribution of the 2D photometric loss component, but embodiments are not limited thereto.

For example, the model can be trained based on the Mean Squared Error (MSE) loss component that ranges on the order of magnitude of 1×10⁻⁷ while the 2D photometric loss component can range on the order of magnitude of 1×10¹. According to an embodiment, the 2D photometric loss can be used to regularize the network and not drown out the MSE loss, e.g., α_{2D} of 1e—7 can be used to scale the loss to an acceptable range, but embodiments are not limited thereto. For example, hyper-parameter optimization can be variously carried out and adjusted according to design consideration and embodiments.

Also, according to embodiments, the mesh generation model can be trained based only the 2D photometric loss, but embodiments are not limited thereto. Also, embodiments are not limited to a dual loss function. For example, according to another embodiment, the mesh generation model can be trained based the 2D photometric loss in addition to one or more other types of losses.

According to embodiments, the mesh generation model can be based on existing models such as FaceFormer and CodeTalker, but modified to include the 2D photometric loss function.

As mentioned above, the overall AI model including the speech style embedding model and the mesh generation model can include a training phase and an inference phase.

The training phase is described in more detail, below.

The training process of the AI model can include receiving an audio speech signal as input. This signal can be first processed by the speech style embedding model, which has been trained on speaker identification tasks. The speech style embedding model analyzes the raw audio and extracts a compact representation of the speaker's unique vocal characteristics, encoded in a 64-dimensional vector called the speech style vector, according to an embodiment. However, vector of other sizes and dimensions can be used.

Then, the speech style vector and the original audio signal are fed into the mesh generation model. The mesh generation model can take these two inputs and translate them into a sequence of 3D meshes that represent the facial animation. According to an embodiment, the output of the mesh generation model can be a tensor containing the vertex positions for each frame of the animation. The number of frames can be determined by the length of the input audio, and the number of vertices can depend on the specific facial mesh used (e.g., 5,023 vertices).

To train the model more effectively, a dual loss function can be used. The first component can be the Mean Squared Error (MSE) loss, which calculates the difference between the predicted mesh sequence and the ground truth animation. This ground truth data can be obtained either from motion capture datasets or generated synthetically using a video-to-mesh model for the data augmentation component that generates augments training data as discussed above.

In addition to the MSE loss, a 2D photometric loss can be used to enhance the visual realism of the generated animations. For example, this can include rendering both the predicted and ground truth animation sequences into videos. By comparing these videos in pixel-space, a 2D photometric loss can be computed that acts as an additional regularization signal. This additional regularization signal can help the model learn the intricate relationship between the 3D mesh vertices and how they look when rendered as a 2D image, leading to more visually convincing animations.

Further, the final loss used to train the model can be a weighted average of the MSE loss and the 2D photometric loss. This combined loss can better guide the model towards generating animations that are both geometrically accurate and visually realistic. This entire process can be iteratively repeated until the AI model converges to a satisfactory level of performance or a predetermined number of iterations.

The inference phase is described in more detail, below. The inference phase is similar to training phase, except loss is not computed, rather the model can generate predicted vertex offsets which can be a tensor that is used for various downstream tasks.

For example, the trained AI model can receive a raw audio speech signal as input. This speech signal is analyzed by the speech style embedding model, which has been pre-trained on speaker identification tasks. The speech style embedding model processes the audio and extracts a unique representation of the speaker's voice (e.g., encoded in a 64-dimensional vector which can be referred to as a speech style vector).

Further, both the raw audio signal and the extracted speech style vector are input into the mesh generation model. The mesh generation model leverages both the input speech signal and the speaker's unique vocal characteristics from the embedding to generate a 3D facial animation.

As discussed above, the output of the mesh generation model is a sequence of 3D meshes, where each mesh represents the facial geometry at a specific point in time. This sequence forms the 3D animation, with the number of frames in the animation corresponding to the length of the input audio. The complexity of the mesh, represented by the number of vertices, can be determined by the specific facial model being used.

Further in this example, the generated animation can be represented as a tensor of mesh sequences, which can then be used for a variety of downstream tasks. For example, these downstream tasks can include one or more of creating realistic avatars for virtual assistants, generating expressive characters for animated films or video games, and even enhancing video conferencing by animating image or character based on the speaker's voice.

In addition, experiments were carried out with different variations of models to illustrate the effectiveness of the trained AI model, according to embodiments.

For example, six different models where evaluated which include two base models of a FaceFormer based model that was trained based on just Mean Squared Error (MSE), and a CodeTalker based model that was trained based on just Mean Squared Error (MSE) for comparison to various embodiments. Also, according to embodiments, the other four models include a FaceFormer^{2D} based model that was trained based on the Mean Squared Error (MSE) and the 2D photometric loss, a FaceFormer^{W2V} based model that was trained based on the Mean Squared Error (MSE) and uses the speech style vector embeddings, a CodeTalker^{W2V} based model that was trained based on the Mean Squared Error (MSE) and uses the speech style vector embeddings, and a CodeTalker^{Joint} based model that was trained based on the Mean Squared Error (MSE) and the 2D photometric loss and uses the speech style vector embeddings.

For example, VOCASET was used to train and test the different models in the experiments, as well as the 3D-MEAD dataset discussed above regarding the data augmentation technique.

Both of the VOCASET and 3D-MEAD datasets contain 3D facial animations paired with English utterances. VOCASET contains 255 unique sentences, which are partially shared among different speakers, yielding 480 animation sequences from 12 unique speakers. Those 12 speakers are split into 8 unique training, 2 unique validation, and 2 unique testing speakers. Each sequence is captured at 60 fps, resamples to 30 fps, and ranges between 3 and 4 seconds.

Further, the same training, validation, and testing splits were used as VOCA and FaceFormer, which can be referred to as VOCA-Train, VOCA-Val, and VOCA-Test. For 3D-MEAD, there are 43 unique speakers, where each speaker has 40 unique sequences, yielding a total of 1680 sequences. The dataset was randomly split into 27, 8 and 8, training, validation and test speakers.

Each split can be referred to as 3D-MEAD-Train, 3D-MEAD-Val, 3D-MEAD-Test. Additionally, 3D-MEAD-Train was subsampled to generate a 3D-MEAD-Train-8 dataset containing only 8 training speakers, similar to VOCASET-Train. In both datasets, face meshes are composed of 5023 vertices.

The quantitative performance of the various model was evaluated using the Lip Vertex Error (LVE) to measure lip synchronization with ground truth. For example, LVE calculates the mean over all frames of the maximal L2 error of all lip vertices.

Table 1 below shows a comparison of the models on the VOCA-Test dataset with respect to the Best LVE. “BEST” refers to refers to the best tested model from the three seeds used to train the same model. Each percent (%) improvement is measured based on a comparison with the best baseline model (CodeTalker).

TABLE 1

| Model | Best LVE (×10⁻⁵ mm) ↓ | % imp. |
|---|---|---|
| FaceFormer | 3.194 | — |
| CodeTalker | 3.137 | — |
| FaceFormer^{2D} | 3.102 | +1.1% |
| FaceFormer^{W2V} | 2.940 | +6.2% |
| CodeTalker^{W2V} | 3.050 | +2.8% |
| CodeTalker^{Joint} | 2.854 | +9.0% |

Table 2 below shows a comparison of the models on the VOCA-Test dataset with respect to Mean LVE. Mean is calculated as the average testing results over the three seeds used to train the same model. Each percent (%) improvement is measured based on a comparison with the best mean baseline model (FaceFormer).

TABLE 2

| Model | Mean LVE (×10⁻⁵ mm) ↓ | % imp. |
|---|---|---|
| FaceFormer | 3.252 ± 0.050 | — |
| CodeTalker | 3.312 ± 0.281 | — |
| FaceFormer^{2D} | 3.172 ± 0.097 | +2.4% |
| FaceFormer^{W2V} | 3.056 ± 0.158 | +6.0% |
| CodeTalker^{W2V} | 3.084 ± 0.033 | +5.2% |
| CodeTalker^{Joint} | 3.012 ± 0.159 | +7.4% |

As shown above, the train AI model according to an embodiment using the Mean Squared Error (MSE), the 2D photometric loss and the speech style vector embeddings had a +9.0% improvement for Best LVE and a +7.4% improvement for Mean LVE.

According to an embodiment, the AI device 100 can be configured to generate speech-driven 3D facial animation. The AI device 100 can be used in various types of different situations.

According to one or more embodiments of the present disclosure, the AI device 100 can solve one or more technological problems in the existing technology, such as automatically generating high-quality 3D facial animation based on an input speech that includes accurate movements and expressions that can dynamically match the given style of the input speech. For example, the AI device can address to need of providing a more accurate AI model capable of achieving realistic and expressive facial animation in interactive applications by leveraging neural networks to predict and generate facial movements with high fidelity and accuracy.

Also, according to an embodiment, the AI device 100 configured with the trained AI model can be used in a mobile terminal, a smart TV, a home appliance, a robot, an infotainment system in a vehicle, etc.

Further, according to an embodiment, the AI device 100 including the trained AI model can implement a method that can include an improved loss function, advanced speaker style embeddings and augmented training data generation to produce a better speech-driven 3D animation model that can provide realistic and expressive facial animation that accurately matches audio.

For example, the AI device can be applied in a wide range of interactive applications including a digital avatar or computer animation.

In addition, the method can use a neural network to animate facial expressions by predicting vertex positions in sync with the input audio.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for speech-driven three dimensional (3D) facial animation, the method comprising:
receiving, by a processor, an input speech audio signal;
generating, by the processor, a speaker style vector from the input speech audio signal based on a speaker style embedding model;
inputting, by the processor, the input speech audio signal and the speaker style vector into a mesh generation model and generating vertex position information for a 3D facial animation based on the input speech audio signal and the speaker style vector; and
outputting, by the processor, the vertex position information.

2. The method of claim 1, further comprising:
displaying the 3D facial animation with animated movements based on the vertex position information.

3. The method of claim 1, wherein the mesh generation model is trained based on a two dimensional (2D) photometric loss function based on inverse rendering of predicted vertex position information and corresponding ground truth vertex position information.

4. The method of claim 3, wherein the 2D photometric loss function includes a mask parameter configured to remove background information to isolate a face.

5. The method of claim 3, wherein the 2D photometric loss function is based on a pixel difference between two 2D images.

6. The method of claim 1, wherein the mesh generation model is trained based on a Mean Squared Error (MSE) loss function.

7. The method of claim 1, wherein the vertex position information includes a tensor of dimension NUMFRAMES×VERTEXCOUNT×3, where NUMFRAMES is a number of frames based on a length of input speech audio signal, VERTEXCOUNT is a number of vertices based on a mesh for the 3D facial animation, and 3 corresponds to x, y and z coordinates.

8. The method of claim 1, wherein the mesh generation model is trained based on augmented training data that includes 3D animation data generated based on 2D videos.

9. The method of claim 1, wherein the generating the speaker style vector includes:
inputting feature vectors based on the input speech audio signal to a transformer encoder and processing the feature vectors through transformer blocks that include self-attention operations; and
generating the speaker style vector based on an output of the transformer encoder.

10. The method of claim 1, wherein the mesh generation model includes a transformer-based vertex decoder configured with causal self-attention and cross-modal attention.

11. An artificial intelligence (AI) device, comprising:
a memory configured to store facial animation information; and
a controller configured to:
receive an input speech audio signal,
generate a speaker style vector from the input speech audio signal based on a speaker style embedding model,
input the input speech audio signal and the speaker style vector into a mesh generation model to generate vertex position information for a 3D facial animation based on the input speech audio signal and the speaker style vector, and
output the vertex position information.

12. The AI device of claim 11, further comprising:
a display configured to display an image,
wherein the controller is further configured to display, via the display, the 3D facial animation with animated movements based on the vertex position information.

13. The AI device of claim 11, wherein the mesh generation model is trained based on a two dimensional (2D) photometric loss function based on inverse rendering of predicted vertex position information and corresponding ground truth vertex position information.

14. The AI device of claim 13, wherein the 2D photometric loss function includes a mask parameter configured to remove background information to isolate a face.

15. The AI device of claim 13, wherein the 2D photometric loss function is based on a pixel difference between two 2D images.

16. The AI device of claim 11, wherein the mesh generation model is trained based on a Mean Squared Error (MSE) loss function.

17. The AI device of claim 11, wherein the vertex position information includes a tensor of dimension NUMFRAMES×VERTEXCOUNT×3, where NUMFRAMES is a number of frames based on a length of input speech audio signal, VERTEXCOUNT is a number of vertices based on a mesh for the 3D facial animation, and 3 corresponds to x, y and z coordinates.

18. The AI device of claim 11, wherein the mesh generation model is trained based on augmented training data that includes 3D animation data generated based on 2D videos.

19. The AI device of claim 11, wherein the controller is further configured to:
input feature vectors based on the input speech audio signal to a transformer encoder in the speaker style embedding model and process the feature vectors through transformer blocks that include self-attention operations, and
generate the speaker style vector based on an output of the transformer encoder.

20. The AI device of claim 11, wherein the mesh generation model includes a transformer-based vertex decoder configured with causal self-attention and cross-modal attention.
